(19) United States
(12) Patent Application Publication
(10) Pub. No.: US 2016/0042100 A1
(43) Pub. Date: Feb. 11, 2016

(54) UNPHYSICAL PHASE SPLIT DETECTION

(71) Applicants: Christopher J. Freitas, San Antonio, TX (US); Nicholas J. Mueschke, San Antonio, TX (US); Nathan F. Andrews, San Antonio, TX (US)

(72) Inventors: Christopher J. Freitas, San Antonio, TX (US); Nicholas J. Mueschke, San Antonio, TX (US); Nathan F. Andrews, San Antonio, TX (US)

(73) Assignee: BAKER HUGHES INCORPORATED, Houston, TX (US)

(21) Appl. No.: 14/451,602

(22) Filed: Aug. 5, 2014

(51) Int. Cl. G06F 17/50; G06F 17/10

(52) U.S. Cl. CPC G06F 17/5009; G06F 17/10

(57) ABSTRACT

An apparatus for estimating conditions of a fluid in an underground reservoir includes one or more sensors for measuring a temperature and a pressure of the fluid a processor that estimates the conditions by enforcing a full liquid requirement to a flash solver when under certain conditions.

### TECHNICAL FIELD

This invention is pertinent to the thermodynamic modeling of reservoir components using cubic equation of state (EOS) models.

### BACKGROUND

Thermodynamic equations of state (EOS) models relate known state variables, such as pressure and temperature (e.g., measured), to unknown state variables, such as volume, density, and fugacity, as well as other fluid parameters. Cubic EOS models are a subclass of the broader class of general thermodynamic EOS models that relate pressure, temperature, and volume through a cubic polynomial function. Such models are used to predict phase behavior and fluid properties in a broad range of applications, including the petrophysical, geophysical, refrigeration, aerospace, and chemical process design industries. Their broad adoption and application is due to the relative simplicity of the model form, ease of computational implementation, limited number of fluid property inputs required for operation, and overall computational robustness.

The cubic EOS model subclass was first developed by van der Waals as an extension to the ideal gas law, where both attractive and repulsive molecular forces are included. Since the initial formulation of a cubic EOS model by van der Waals, numerous modifications to the model form have been made in an effort to increase predictive accuracy and general applicability. Of note are the Soave-Redlich-Kwong (SRK) and Peng-Robinson (PR) model forms, which achieved broad adoption and use in industrial applications. Both the SRK and PR models may expressed in a universal form:

$$P = \frac{RT}{V - b} - \frac{a α}{{V}^{2} + {u}_{1} bV + {u}_{2} {b}^{2}} \qquad ( 1 )$$

where P is pressure, T is temperature, V is volume, R is the universal gas constant, a and b are attractive and repulsive parameters specific to each pure substance or mixture, and u₁ and u₂ are model-specific constants. The values and model forms for a, α, b, u₁, and u₂ for the SRK and PR model forms are listed in Table 1 below. Expressed in its cubic polynomial form, the SRK and PR models may be written as:

Z³−(1+B−u₁B)Z²+(A+u₂B²−u₁B−u₁B²)Z−(AB+u₂B²+u₂B³)=0 (2)

where Z is the compressibility factor, with

$$A = \frac{{( a α )}_{mix} P}{{R}^{2} {T}^{2}} , and B = \frac{{b}_{mix} P}{RT} . \qquad ( 3 )$$

The attractive and repulsive terms for mixtures are calculated using standard mixing rules and are given by:

(αα)ₘᵢₓ=Σᵢ^{N}Σⱼ^{N}[XᵢXⱼ\sqrt{aᵢaⱼαᵢαⱼ}(1−kᵢⱼ)], (4)

bₘᵢₓ=Σᵢ^{N}Xᵢbᵢ, (5)

where Xᵢ is the mole fraction of each component in the phase of interest (liquid, Xᵢ, or gas Yᵢ) and kᵢⱼ are binary interaction coefficients.

TABLE 1
SRK and PR cubic EOS parameters.

| Model | a | α | b | Ωₐ | Ω_{b} | u₁ | u₂ |
|---|---|---|---|---|---|---|---|
| SRK | $\frac{{Ω}_{a} {R}^{2} {T}_{c}^{2}}{{P}_{c}}$ | [1 + f_{ω}(1 − Tᵣ^{0.5})]² f_{ω} = 0.48 + 1.574ω − 0.176ω² | $\frac{{Ω}_{b} {RT}_{c}}{{P}_{c}}$ | 0.42748 | 0.08664 | 1 | 0 |
| PR | $\frac{{Ω}_{a} {R}^{2} {T}_{c}^{2}}{{P}_{c}}$ | [1 + f_{ω}(1 − Tᵣ^{0.5})]² f_{ω} = 0.37464 + 1.54226ω − 0.2699ω² | $\frac{{Ω}_{b} {RT}_{c}}{{P}_{c}}$ | 0.45724 | 0.07780 | 2 | −1 |

Provided physical properties for each mixture component, a cubic EOS may be used to calculate the compressibility factor Z for each potential phase (liquid and vapor phases). However, the determination of the phase state (liquid, vapor, or some combination of each) is a function of the fugacity of each component. Vapor-liquid equilibrium is achieved when the fugacity of the vapor phase (real or potential vapor phase) and the fugacity of the liquid phase (real or potential liquid phase) are equal for each component in the mixture

fᵢ^{liq}=fᵢ^{vap} (6)

This may also be expressed in the form of the equilibrium ratio:

$${K}_{i} = \frac{{y}_{i}}{{x}_{i}} \frac{{f}_{i}^{liq}}{{f}_{i}^{vap}} = \frac{{ϕ}_{i}^{liq}}{{ϕ}_{i}^{vap}} \qquad ( 7 )$$

where φᵢ^{liq}=fᵢ^{liq}/xᵢP is the liquid-phase fugacity coefficient and φᵢ^{vap}=fᵢ^{vap}/yᵢP is the vapor-phase fugacity coefficient. The fugacity coefficient of each component may be calculated by

$$\begin{matrix}ln ( {ϕ}_{i}^{liq} ) = \frac{{b}_{i} ( {Z}_{liq} - 1 )}{{b}_{mix}} - ln ( {Z}_{liq} - {B}_{liq} ) - \frac{{A}_{liq}}{{B}_{liq} ( {δ}_{2} - {δ}_{1} )} ( \frac{2 {Ψ}_{i}^{liq}}{{( a α )}_{mix}} - \frac{{b}_{i}}{{b}_{mix}} ) ln ( \frac{{Z}_{liq} + {δ}_{1} {B}_{liq}}{{Z}_{liq} + {δ}_{2} {B}_{liq}} ) & ( 8 ) \\ ln ( {ϕ}_{i}^{vap} ) = \frac{{b}_{i} ( {Z}_{vap} - 1 )}{{b}_{mix}} - ln ( {Z}_{vap} - {B}_{vap} ) - \frac{{A}_{vap}}{{B}_{vap} ( {δ}_{2} - {δ}_{1} )} ( \frac{2 {Ψ}_{i}^{vap}}{{( a α )}_{mix}} - \frac{{b}_{i}}{{b}_{mix}} ) ln ( \frac{{Z}_{vap} + {δ}_{1} {B}_{vap}}{{Z}_{vap} + {δ}_{2} {B}_{vap}} ) & ( 9 ) \\ {Ψ}_{i}^{liq} = {\sum }_{j}^{N} [ {x}_{j} \sqrt{{a}_{i} {a}_{j} {α}_{i} {α}_{j}} ( 1 - {k}_{ij} ) ] , and {Ψ}_{i}^{vap} = {\sum }_{j}^{N} [ {y}_{j} \sqrt{{a}_{i} {a}_{j} {α}_{i} {α}_{j}} ( 1 - {k}_{ij} ) ] & ( 10 )\end{matrix}$$

For SRK models, δ₁=1 and δ₂=0. For the PR model, δ₁=1+\sqrt{2} and δ₂=1−\sqrt{2}.

In order to determine the liquid/vapor quality of a mixture, the Rachford-Rice equation must be solved for the function g, which depends upon the composition of the mixture and the equilibrium ratio.

$$ℊ ( {n}_{vap} ) = {z}_{i} \frac{{K}_{i} - 1}{1 - {n}_{vap} + {n}_{vap} {K}_{i}} = 0 \qquad ( 11 )$$

The solution to the Rachford-Rice equation contains a physical solution, i.e., the mole fraction of vapor existing on the interval 0<nᵥₐₚ<1, if both g(0)≧1.0 and g(1)≧1.0 , where

$$\begin{matrix}ℊ ( 0 ) = {\sum }_{1}^{N} {z}_{i} {K}_{i} ; and & ( 12 ) \\ ℊ ( 1 ) = {\sum }_{1}^{N} \frac{{z}_{i}}{{K}_{i}} ; & ( 13 )\end{matrix}$$

If g(0)<1.0, then the substance or mixture is expected to exist entirely as a liquid-phase fluid. Conversely, if g(1)<1.0, then the substance or mixture is expected to exist entirely as a vapor-phase fluid. Thus, given values for the equilibrium ratio Kᵢ, this check allows for the EOS to determine the phase state of a substance or mixture.

Since a priori knowledge of the Kᵢ is generally not available for any arbitrary mixture at any pressure-temperature state condition, the solution to a cubic EOS, property mixture rules, and fugacity formulation is performed in an iterative manner with an initial guess for Kᵢ provided. Typically, that initial seeding guess is provided by Wilson's Kᵢ correlation:

$${K}_{i} = \frac{{P}_{c , i}}{P} exp [ 5.373 ( 1 + {ω}_{i} ) ( 1 - \frac{{T}_{c , i}}{T} ) ] \qquad ( 14 )$$

### SUMMARY

According to one embodiment, an apparatus for estimating conditions of a fluid in an underground reservoir that includes one or more sensors for measuring a temperature and a pressure of the fluid and processor is disclosed. The processor is configured to: receive data representing the temperature and the pressure; determine if any component of the fluid will exist entirely as a liquid at the pressure and the temperature; high-pass filter binary interaction coefficients between hydrocarbon components and select non-hydrocarbon components over limited temperature ranges; initialize the equilibrium ratio based on the temperature, pressure and feed composition; select either a first method or second method, different than the first method, of calculating the phase state of the fluid, the decision based on the determination of the fluid mixture existing entirely as a liquid as previously determined; wherein the first method is selected when at least one component does not exist entirely as a liquid when evaluated individually at the pressure and temperature, and the second method is selected when all components exist entirely as a liquid when evaluated individually; based on results of the first or second method, estimate the compressibility factor, fugacity, and equilibrium ratio of the mixture phase states; and determine the convergence of the equilibrium ratio.

According to another embodiment, computer based method of estimating saturation conditions of reservoir fluids in an underground reservoir is disclosed. The method includes receiving data representing the temperature and the pressure; determining if any component of the fluid will exist entirely as a liquid at the pressure and the temperature; high-pass filtering binary interaction coefficients between hydrocarbon components and select non-hydrocarbon components over limited temperature ranges; initializing the equilibrium ratio based on the temperature, pressure and feed composition; selecting, with a processor, either a first method or second method, different than the first method, of calculating the phase state of the fluid, the decision based on the determination of the fluid mixture existing entirely as a liquid as previously determined; wherein the first method is selected when at least one component does not exist entirely as a liquid when evaluated individually at the pressure and temperature, and the second method is selected when all components exist entirely as a liquid when evaluated individually; based on results of the first or second method, estimating the compressibility factor, fugacity, and equilibrium ratio of the mixture phase states; and determining the convergence of the equilibrium ratio.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 shows an example drilling system according to one embodiment;

FIG. 2 is a flow diagram illustrating an example of a method according to one embodiment; and

FIG. 3 is a flow diagram illustrating an example of a method according to one embodiment.

### DETAILED DESCRIPTION

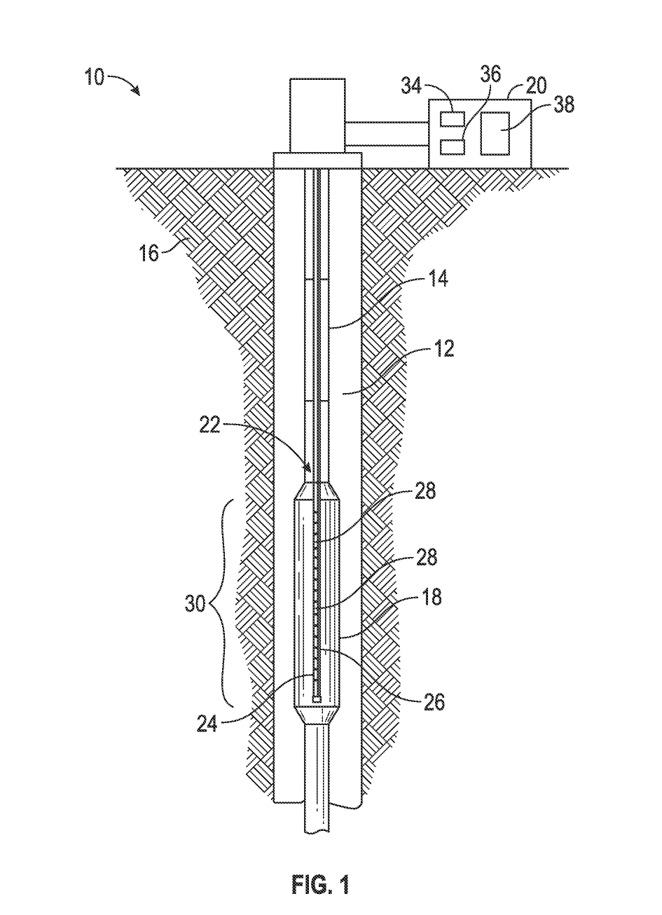

Referring to FIG. 1, an exemplary embodiment of a downhole drilling, monitoring, evaluation, exploration and/or production system 10 disposed in a wellbore 12 is shown. A borehole string 14 is disposed in the wellbore 12, which penetrates at least one earth formation 16 for performing functions such as extracting matter from the formation and/or making measurements of properties of the formation 16 and/or the wellbore 12 downhole. The borehole string 14 is made from, for example, a pipe, multiple pipe sections or flexible tubing. The system 10 and/or the borehole string 14 include any number of downhole tools 18 for various processes including drilling, hydrocarbon production, and measuring one or more physical quantities in or around a borehole. Various measurement tools 18 may be incorporated into the system 10 to affect measurement regimes such as wireline measurement applications or logging-while-drilling (LWD) applications.

In one embodiment, a parameter measurement system is included as part of the system 10 and is configured to measure or estimate various downhole parameters of the formation 16, the borehole 14, the tool 18 and/or other downhole components. The illustrated measurement system includes an optical interrogator or measurement unit 20 connected in operable communication with at least one optical fiber sensing assembly 22. The measurement unit 20 may be located, for example, at a surface location, a subsea location and/or a surface location on a marine well platform or a marine craft. The measurement unit 20 may also be incorporated with the borehole string 14 or tool 18, or otherwise disposed downhole as desired.

In the illustrated embodiment, an optical fiber sensing assembly 22 is operably connected to the measurement unit 20 and is configured to be disposed downhole. The optical fiber sensing assembly 22 includes at least one optical fiber core 24 (referred to as a “sensor core” 24) configured to take a distributed measurement of a downhole parameter (e.g., temperature, pressure, stress, strain and others). In one embodiment, the system may optionally include at least one optical fiber core 26 (referred to as a “system reference core” 26) configured to generate a reference signal. The sensor core 24 includes one or more sensing locations 28 disposed along a length of the sensor core 24, which are configured to reflect and/or scatter optical interrogation signals transmitted by the measurement unit 20. Examples of sensing locations 28 include fiber Bragg gratings, Fabry-Perot cavities, partially reflecting mirrors, and locations of intrinsic scattering such as Rayleigh scattering, Brillouin scattering and Raman scattering locations. If included, the system reference core 26 may be disposed in a fixed relationship to the sensor core 24 and provides a reference optical path having an effective cavity length that is stable relative to the optical path cavity length of the sensor core 24.

In one embodiment, a length of the optical fiber sensing assembly 22 defines a measurement region 30 along which distributed parameter measurements may be taken. For example, the measurement region 30 extends along a length of the assembly that includes sensor core sensing locations 28.

The measurement unit 20 includes, for example, one or more electromagnetic signal sources 34 such as a tunable light source, a LED and/or a laser, and one or more signal detectors 36 (e.g., photodiodes). Signal processing electronics may also be included in the measurement unit 20, for combining reflected signals and/or processing the signals. In one embodiment, a processing unit 38 is in operable communication with the signal source 34 and the detector 36 and is configured to control the source 34, receive reflected signal data from the detector 36 and/or process reflected signal data.

In one embodiment, the measurement system is configured as a coherent optical frequency-domain reflectometry (OFDR) system. In this embodiment, the source 34 includes a continuously tunable laser that is used to spectrally interrogate the optical fiber sensing assembly 22.

The optical fiber sensing assembly 22 and/or the measurement system are not limited to the embodiments described herein, and may be disposed with any suitable carrier. That is, while an optical fiber sensing assembly 22 is shown, any type of now known or later developed manners of obtaining information relative a reservoir may be utilized to measure various information (e.g., temperature, pressure, salinity and the like) about fluids in a reservoir. Thus, in one embodiment, the measurement system may not employ any fibers at all and may communicate data electrically.

A “carrier” as described herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include casing pipes, wirelines, wireline sondes, slickline sondes, drop shots, downhole subs, bottom-hole assemblies, and drill strings.

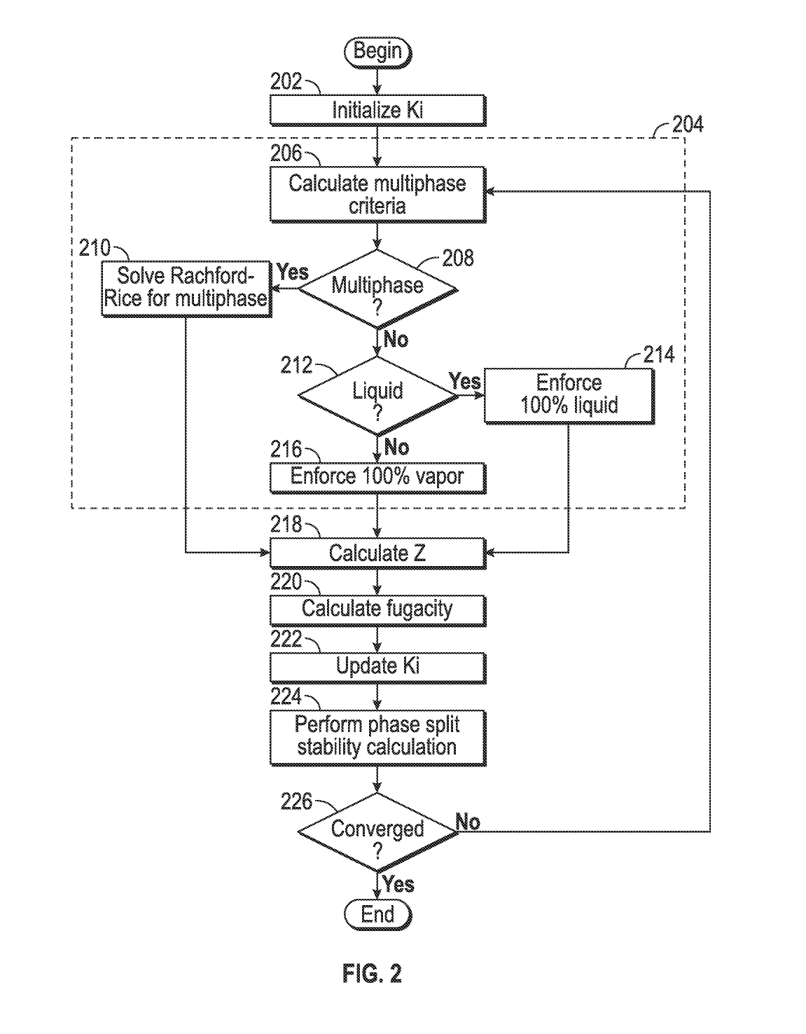

FIG. 2 is a flow chart showing an example of a two-phase flash algorithm. Flash algorithms generally are known and refer to algorithms that may solve, based on measured temperatures and pressures, the vapor/liquid state of components making up a mixture or a single element. The process assumes inputs of T and P that may be measured, for example, in reservoir by a system as shown, for example, in FIG. 1.

At block 202, the flash algorithm begins by initializing Kᵢ. According to one embodiment, this may include providing an initial seeding guess as provided by Wilson's Kᵢ correlation, equation 14:

$${K}_{i} = \frac{{P}_{c , i}}{P} exp [ 5.373 ( 1 + {ω}_{i} ) ( 1 - \frac{{T}_{c , i}}{T} ) ] \qquad ( 14 )$$

At block 204 the values needed to calculate the compressibility factor (Z) are determined. In particular, these values may include the mole fractions and compositions of the liquid/vapor in the fluid. In more detail, block 204 includes several steps that include determination of the liquid/vapor phase. Such a determination may include, in one embodiment, at block 206 solving the equilibrium ratio constraints, equations 12-13:

$$\begin{matrix}ℊ ( 0 ) = {\sum }_{1}^{N} {z}_{i} {K}_{i} ; and & ( 12 ) \\ ℊ ( 1 ) = {\sum }_{1}^{N} \frac{{z}_{i}}{{K}_{i}} ; & ( 13 )\end{matrix}$$

where zᵢ is the feed composition. If both g(0) and g(1) are both greater than 1.0 (as determined at block 208) then the fluid is multiphase and the Rachford-Rice equation is solved for a multiphase liquid at block 210. Otherwise, if g(0)<1.0, as determined at block 212, then the substance or mixture is expected to exist entirely as a liquid-phase fluid and processing proceeds to block 214 where the vapor-phase mole fraction is set to 0. Conversely, if g(1)<1.0, then the substance or mixture is expected to exist entirely as a vapor-phase fluid and the vapor-phase mole fraction is set to 1.0 at block 216.

At block 218 the compressibility factor Z is calculated based on the calculated mole fractions, Xᵢ, where Xᵢ is the mole fraction of each component in the phase of interest (liquid, xᵢ, or gas yᵢ). This may include solving equation 2:

Z³−(1+B−u₁B)Z²+(A+u₂B²−u₁B−u₁B²)Z−(AB+u₂B²+u₂B³)=0, (2)

where Z is the compressibility factor, with coefficients specified by equation 3

$$A = \frac{{( a α )}_{mix} P}{{R}^{2} {T}^{2}} , and B = \frac{{b}_{mix} P}{RT} . \qquad ( 3 )$$

The attractive and repulsive terms for mixtures are calculated using standard mixing rules and are given by equations 4-5:

(aα)ₘᵢₓΣᵢ^{N}Σⱼ^{N}[XᵢXⱼ\sqrt{aᵢaⱼαᵢαⱼ}(1−kᵢⱼ)], (4)

bₘᵢₓ=Σᵢ^{N}Xᵢbᵢ, (5)

where kᵢⱼ are binary interaction coefficients.

At block 220 fugacity is calculated based on equations 8-10 above. At block 222 the equilibrium ratios (Kᵢ) are updated by utilizing equation 7:

$${K}_{i} = \frac{{y}_{i}}{{x}_{i}} \frac{{f}_{i}^{liq}}{{f}_{i}^{vap}} = \frac{{ϕ}_{i}^{liq}}{{ϕ}_{i}^{vap}} \qquad ( 7 )$$

Optionally, at block 224 a phase split stability analysis may be performed, the methods for which are not addressed further herein as they are standard methods in flash solvers which can be found in the open literature. At block 226 it is determined if the equilibrium ratio has converged. This may include satisfying the multi-phase convergence criteria:

$${ɛ}_{multiphase} = {{\sum }_{i}}^{N} {( 1 - \frac{{f}_{i}^{liq}}{{f}_{i}^{vap}} )}^{2} \qquad ( 15 )$$

or one of two single-phase convergence criteria:

$$\begin{matrix}{ɛ}_{composition} = {\sum }_{i}^{N} [ {( {x}_{i}^{k + 1} - {x}_{i}^{k} )}^{2} + {( {y}_{i}^{k + 1} - {y}_{i}^{k} )}^{2} ] & ( 16 ) \\ {ɛ}_{trivial} = {\sum }_{i}^{N} {( {x}_{i}^{k + 1} - {y}_{i}^{k + 1} )}^{2} . & ( 17 )\end{matrix}$$

where k is the old estimation of values and k+1 is the current estimation. If one of these criteria is satisfied to within an adjustable tolerance value of ε, then the flash calculation is terminated and further property calculations can be implemented. Otherwise, processing returns to block 206.

The application of a two-phase flash algorithm as described above to any arbitrary mixture at any pressure and temperature condition may be limited due to several inherent assumptions underlying the algorithm. The two-phase flash algorithm is restricted to the prediction of phase equilibria for the case of one vapor phase and one liquid phase. The application of the algorithm to pressure and temperature conditions where additional phases exist (solid phases, additional immiscible liquid phases) may result in unphysical phase and property predictions. For example, at sufficiently low temperatures, some or all of a single component mixture may form a solid phase. Thus, two-phase liquid/vapor flash algorithms are not intended to or capable of predicting the formation of solid phases nor calculating their properties.

Furthermore, two-phase flash models are not capable of accounting for the complex molecular interactions that may result in multiple immiscible liquid phases existing at a given (P,T) state condition. Van Konynenburg and Scott developed the foundational theory and classification guidelines for binary mixtures. Based upon the van der Waals cubic EOS, they were able to group mixtures with disparate molecular size and attractive/repulsive coefficients into five primary mixture types. Further research by Deiters and Pegg and Wang and Sadus using EOS models based on different principles have demonstrated the ability of those model forms to reveal additional mixture types. Type I mixtures are the only mixture type that have only one potential liquid phase and one potential vapor phase at any given pressure/temperature state (excluding regions where solids may form). These mixtures are modeled well by two-phase flash algorithms. Examples of Type I mixtures include C₁H₄—C₂H₆ mixtures and C₂H₆—C₇H₁₆ mixtures. All other mixture types as identified by van Konynenburg and Scott may result in the possible formation of multiple immiscible liquids depending upon pressure/temperature state. In the case of Type V mixtures, the pressure and temperature state regions that result in multiple immiscible liquids are generally small and localized to a small region of low-pressure/low-temperature space. An example of a Type V mixture includes a C₁H₄—C₈H₁₈ mixture. Type II-IV mixtures represent the hardest class of mixtures for two-phase flash algorithms to handle, as they result in liquid-liquid phase splits over a broad range of pressures, but are typically restricted to relatively lower temperatures. An example of a Type II mixture is a C₈H₁₈—CO₂ mixture. For mixtures that demonstrate the liquid-liquid phase split behavior typical of Type II mixtures, two-phase flash algorithms will erroneously report the existence of a vapor-liquid phase split. This error may lead to gross errors in predicting the mixture quality and subsequent properties.

For some mixtures, cubic EOS algorithms will converge to a multiphase vapor/liquid equilibrium solution at sufficiently cold temperatures where the existence of a vapor phase is unphysical due to the low temperature state. This erroneous multiphase vapor/liquid split is the result of the mathematical model's inability to handle multiple immiscible liquid phases, as discussed above. Disclosed herein is an algorithm that may prevent the flash algorithm from reporting an unphysical multiphase mixture at these temperatures. The overall algorithm itself is comprised of two additional algorithms which are executed prior to the execution of the two-phase flash algorithm. The first process evaluates the phase (liquid or vapor) of each constituent of the mixture by itself at the pressure and temperature conditions specified for the mixture flash calculation. The second algorithm modifies certain nonhydrocarbon-related binary interaction coefficients. Combined, these two algorithms eliminate the erroneous prediction of false vapor-liquid phase splits at low temperatures for Type II mixtures and minimizes (or potentially eliminates) false multiphase splits for more complex Type III and IV mixtures.

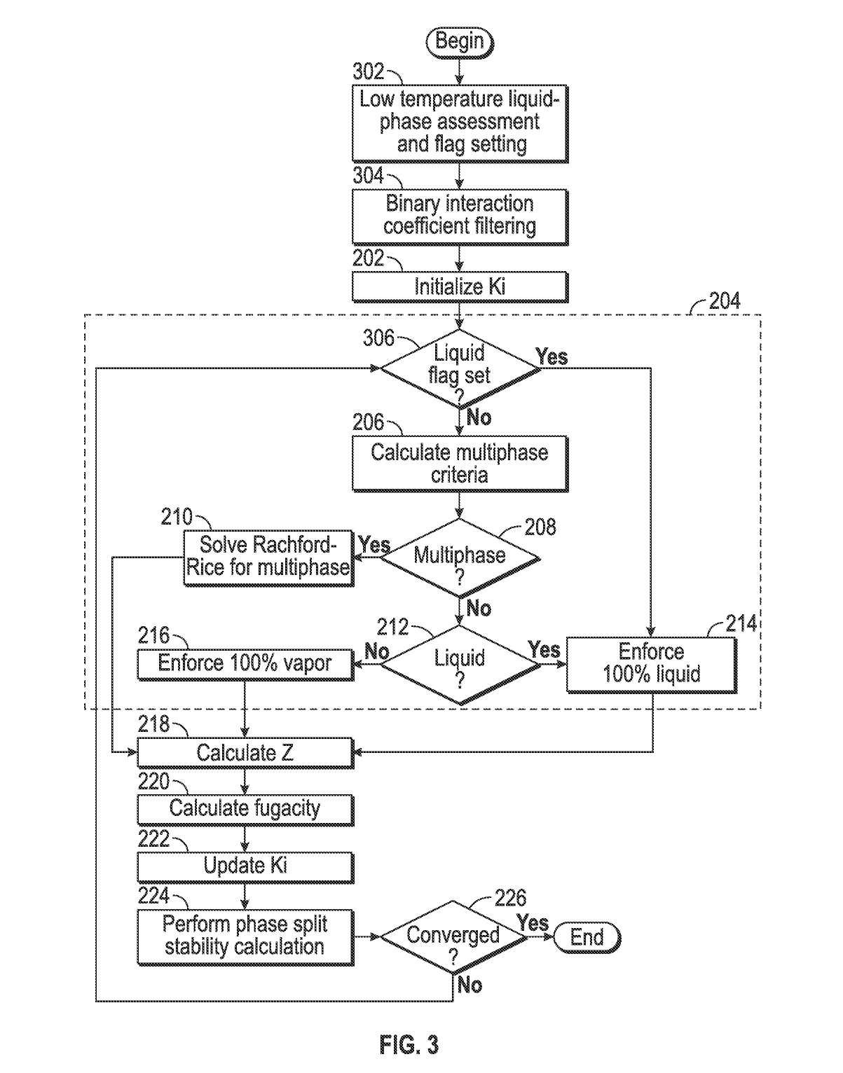

FIG. 3 shows a flow chart of a method according to another embodiment. The method begins at block 302. In order to prevent the false detection of a multiphase vapor/liquid mixture, the algorithm of the standard two-phase flash solver has been augmented by adding this pre-calculation step (block 302) prior to the application of the iterative flash solution for the mixture. This pre-calculation step involves performing a series of single-component flash calculations for each component in the mixture, at a specified pressure and temperature (P,T) state. The (P,T) state is taken to be the same (P,T) state as where the multi-component mixture is to be evaluated. If the collection of single component flash calculations performed during this pre-calculation step indicates that each component in the mixture, when considered only as a pure substance, will exist entirely as a liquid phase, then a flag is set to indicate that the mixture quality of the composition must also be held fixed at 100% liquid phase for the duration of the iterative multi-component mixture flash calculation. Similarly, if any single component flash calculation performed as part of the pre-calculation step indicates that at least one component exists in a vapor phase, then the flag indicating 100% liquid phase mixture composition will not be set.

The algorithm outlined here may be sensitive to multi-component mixtures with components that have very low critical temperatures, such as hydrogen (Tc=33.24 K) and helium (Tc=5.19 K). Such components do not exist as a liquid over the applicable temperature range for hydrocarbon analysis. To prevent components such as helium from negating the operation of this algorithm, a threshold critical temperature is established. When evaluating the phase quality of each individual component of a mixture, any components with a critical temperature below the critical temperature threshold will be excluded from the application of the algorithm. As a default, the algorithm excludes any component with a critical temperature below 100 K.

Binary interaction coefficients (BIC) are empirically-determined model parameters to modify the attractive term in a cubic EOS when applied to multi-component mixtures. At block 304 such BIC coefficients are calculated. In one embodiment, including non-zero BIC values may provide a more accurate representation of the multiphase (P,T) envelope. However, the use of non-zero BIC values may result in an amplification of the nonphysical phase split phenomena described above, and may potentially alter the mixture type altogether. This amplification of non-physical vapor/liquid phase splits by non-zero BIC values is readily observed in CO₂-hydrocarbon and H₂S-hydrocarbon mixtures. To remedy the amplification of the unphysical phase split problem, a novel algorithm was developed where the binary interaction coefficients between select non-hydrocarbon components (H₂S and CO₂) and the remaining components in the mixture are high-pass filtered. Specifically, the BIC value between H₂S and any other component is linearly interpolated between zero and its originally-specified value over the temperature range of −100° F. and 100° F. Similarly, the BIC value between CO₂ and any other component is linearly interpolated between a value of zero and its originally-specified value for temperatures ranging from −200.0° F. to 25° F. This process essentially “high-pass filters” the BIC values below specified threshold temperatures. By applying this BIC high-pass filtering technique, the artificial amplification and prediction of nonphysical phase splits at lower temperatures is eliminated for Type II mixtures and minimized or eliminated for Type III and IV mixtures.

As before, processing then proceeds to block 202 where K, is initialized. If the flag was set in block 302, then 100% liquid is always enforced. Otherwise, processing is the same as described for FIG. 2, using like numbers in FIGS. 2 and 3 to refer to the same steps in both figures, beginning at block 206.

In support of the teachings herein, various analysis components may be used, including a digital and/or an analog system. Components of the system, such as the measurement unit 20, the processor 38, the processing assembly 50 and other components of the system 10, may have components such as a processor, storage media, memory, input, output, communications link, user interfaces, software programs, signal processors (digital or analog) and other such components (such as resistors, capacitors, inductors and others) to provide for operation and analyses of the apparatus and methods disclosed herein in any of several manners well appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling unit, heating unit, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Of course, additional processing could also be performed in one or more embodiments.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating conditions of a fluid in an underground reservoir, the apparatus comprising:
one or more sensors for measuring a temperature and a pressure of the fluid; and
a processor, the processor configured to:
receive data representing the temperature and the pressure;
determine if any component of the fluid will exist entirely as a liquid at the pressure and the temperature;
high-pass filter binary interaction coefficients between hydrocarbon components and select non-hydrocarbon components over limited temperature ranges;
initialize the equilibrium ratio based on the temperature, pressure and feed composition;
select either a first method or second method, different than the first method, of calculating the phase state of the fluid, the decision based on the determination of the fluid mixture existing entirely as a liquid as previously determined;
wherein the first method is selected when at least one component does not exist entirely as a liquid when evaluated individually at the pressure and temperature, and the second method is selected when all components exist entirely as a liquid when evaluated individually;
based on results of the first or second method, estimate the compressibility factor, fugacity, and equilibrium ratio of the mixture phase states; and
determine the convergence of the equilibrium ratio.

2. The apparatus of claim 1, wherein, the equilibrium ratio can be first estimated by:
$${K}_{i} = \frac{{P}_{c , i}}{P} exp [ 5.373 ( 1 + {ω}_{i} ) ( 1 - \frac{{T}_{c , i}}{T} ) ]$$

3. The apparatus of claim 1, wherein, in the first method, the processor determines if the fluid includes single-phase or multiphase quality by evaluating the criteria:
$$g ( 0 ) = {\sum }_{1}^{N} {z}_{i} {K}_{i} ; and g ( 1 ) = {\sum }_{1}^{N} \frac{{z}_{i}}{{K}_{i}} .$$

4. The apparatus of claim 3, if a multiphase fluid is expected, wherein the processor estimates the compositions and mole fractions of the mixture phases based on the Rachford-Rice equation:
$$g ( {n}_{vap} ) = {z}_{i} \frac{{K}_{i} - 1}{1 - {n}_{vap} + {n}_{vap} {K}_{i}} = 0$$

5. The apparatus of claim 3, if a single-phase fluid is expected, wherein the processor enforces 100% vapor or liquid mole fractions and composition.

6. The apparatus of claim 1, wherein compressibility factors, fugacities, and equilibrium ratios are estimated based on the phase states and progressively iterated to convergence.

7. The apparatus of claim 6, wherein Z is equal to (equation 2-5):
Z³−(1+B−u₁B)Z²+(A+u₂B²−u₁B−u₁B²)Z−(AB+u₂B²+u₂B³)=0,
where
$$A = \frac{{( a α )}_{m ix} P}{{R}^{2} {T}^{2}} and B = \frac{{b}_{m ix} P}{RT}$$
$${( a α )}_{m ix} = {\sum }_{i}^{N} {\sum }_{j}^{N} [ {X}_{i} {X}_{j} \sqrt{{a}_{i} {a}_{j} {α}_{i} {α}_{j}} ( 1 - {k}_{ij} ) ] , \\ {b}_{m ix} = {\sum }_{i}^{N} {X}_{i} {b}_{i} ,$$

8. The apparatus of claim 6, wherein the fugacity is equal to:
$$ln ( {ϕ}_{i}^{liq} ) = \frac{{b}_{i} ( {Z}_{liq} - 1 )}{{b}_{m i x}} - ln ( {Z}_{liq} - {B}_{liq} ) - \frac{{A}_{liq}}{{B}_{liq} ( {δ}_{2} - {δ}_{1} )} ( \frac{2 {Ψ}_{i}^{liq}}{{( a α )}_{m ix}} - \frac{{b}_{i}}{{b}_{mix}} ) ln ( \frac{{Z}_{liq} + {δ}_{1} {B}_{liq}}{{Z}_{liq} + {δ}_{2} {B}_{liq}} )$$
$$ln ( {ϕ}_{i}^{vap} ) = \frac{{b}_{i} ( {Z}_{vap} - 1 )}{{b}_{mix}} - ln ( {Z}_{vap} - {B}_{vap} ) - \frac{{A}_{vap}}{{B}_{vap} ( {δ}_{2} - {δ}_{1} )} ( \frac{2 {Ψ}_{i}^{vap}}{{( a α )}_{mix}} - \frac{{b}_{i}}{{b}_{mix}} ) ln ( \frac{{Z}_{vap} + {δ}_{1} {B}_{vap}}{{Z}_{vap} + {δ}_{2} {B}_{vap}} )$$
$${Ψ}_{i}^{liq} = {\sum }_{j}^{N} [ {x}_{j} \sqrt{{a}_{i} {a}_{j} {α}_{i} {α}_{j}} ( 1 - {k}_{ij} ) ] , and {Ψ}_{i}^{vap} = {\sum }_{j}^{N} [ {y}_{j} \sqrt{{a}_{i} {a}_{j} {α}_{i} {α}_{j}} ( 1 - {k}_{ij} ) ]$$

9. The apparatus of claim 6, where the equilibrium ratio is equal to:
$${K}_{i} = \frac{{y}_{i}}{{x}_{i}} \frac{{f}_{i}^{liq}}{{f}_{i}^{vap}} = \frac{{ϕ}_{i}^{liq}}{{ϕ}_{i}^{vap}}$$

10. A computer based method of estimating saturation conditions of reservoir fluids in an underground reservoir, the method comprising:
receiving data representing the temperature and the pressure;
determining if any component of the fluid will exist entirely as a liquid at the pressure and the temperature;
high-pass filtering binary interaction coefficients between hydrocarbon components and select non-hydrocarbon components over limited temperature ranges;
initializing the equilibrium ratio based on the temperature, pressure and feed composition;
selecting, with a processor, either a first method or second method, different than the first method, of calculating the phase state of the fluid, the decision based on the determination of the fluid mixture existing entirely as a liquid as previously determined;
wherein the first method is selected when at least one component does not exist entirely as a liquid when evaluated individually at the pressure and temperature, and the second method is selected when all components exist entirely as a liquid when evaluated individually;
based on results of the first or second method, estimating the compressibility factor, fugacity, and equilibrium ratio of the mixture phase states; and
determining the convergence of the equilibrium ratio.

11. The method of claim 10, wherein, the equilibrium ratio can be first estimated by:
$${K}_{i} = \frac{{P}_{c , i}}{P} exp [ 5.373 ( 1 + {ω}_{i} ) ( 1 - \frac{{T}_{c , i}}{T} ) ]$$

12. The method of claim 10, wherein, in the first method, the processor determines if the fluid includes single-phase or multiphase quality by evaluating the criteria:
$$g ( 0 ) = {\sum }_{1}^{N} {z}_{i} {K}_{i} ; and g ( 1 ) = {\sum }_{1}^{N} \frac{{z}_{i}}{{K}_{i}} ;$$

13. The method of claim 12, if a multiphase fluid is expected, wherein the processor estimates the compositions and mole fractions of the mixture phases based on the Rachford-Rice equation:
$$g ( {n}_{vap} ) = {z}_{i} \frac{{K}_{i} - 1}{1 - {n}_{vap} + {n}_{vap} {K}_{i}} = 0$$

14. The method of claim 12, if a single-phase fluid is expected, wherein the processor enforces 100% vapor or liquid mole fractions and composition.

15. The method of claim 10, wherein compressibility factors, fugacities, and equilibrium ratios are estimated based on the phase states and progressively iterated to convergence.

16. The method of claim 15, wherein compressibility factor Z is equal to:
Z³−(1+B−u₁B)Z²+(A+u₂B²−u₁B−u₁B²)Z−(AB+u₂B²+u₂B³)=0,
where
$$A = \frac{{( a α )}_{mix} P}{{R}^{2} {T}^{2}} and B = \frac{{b}_{mix} P}{RT}$$
$${( a α )}_{mix} = {\sum }_{i}^{N} {\sum }_{j}^{N} [ {X}_{i} {X}_{j} \sqrt{{a}_{i} {a}_{j} {α}_{i} {α}_{j}} ( 1 - {k}_{ij} ) ] , \\ {b}_{mix} = {\sum }_{i}^{N} {X}_{i} {b}_{i} ,$$

17. The method of claim 15, wherein the fugacity is equal to:
$$ln ( {ϕ}_{i}^{liq} ) = \frac{{b}_{i} ( {Z}_{liq} - 1 )}{{b}_{mix}} - ln ( {Z}_{liq} - {B}_{liq} ) - \frac{{A}_{liq}}{{B}_{liq} ( {δ}_{2} - {δ}_{1} )} ( \frac{2 {Ψ}_{i}^{liq}}{{( a α )}_{mix}} - \frac{{b}_{i}}{{b}_{mix}} ) ln ( \frac{{Z}_{liq} + {δ}_{1} {B}_{liq}}{{Z}_{liq} + {δ}_{2} {B}_{liq}} )$$
$$ln ( {ϕ}_{i}^{vap} ) = \frac{{b}_{i} ( {Z}_{vap} - 1 )}{{b}_{mix}} - ln ( {Z}_{vap} - {B}_{vap} ) - \frac{{A}_{vap}}{{B}_{vap} ( {δ}_{2} - {δ}_{1} )} ( \frac{2 {Ψ}_{i}^{vap}}{{( a α )}_{mix}} - \frac{{b}_{i}}{{b}_{ma x}} ) ln ( \frac{{Z}_{vap} + {δ}_{1} {B}_{vap}}{{Z}_{vap} + {δ}_{2} {B}_{vap}} )$$
$${Ψ}_{i}^{liq} = {\sum }_{j}^{N} [ {x}_{j} \sqrt{{a}_{i} {a}_{j} {α}_{i} {α}_{j}} ( 1 - {k}_{ij} ) ] , \\ and {Ψ}_{i}^{vap} = {\sum }_{j}^{N} [ {y}_{j} \sqrt{{a}_{i} {a}_{j} {α}_{i} {α}_{j}} ( 1 - {k}_{ij} ) ]$$

18. The method of claim 15, where the equilibrium ratio is equal to:
$${K}_{i} = \frac{{y}_{i}}{{x}_{i}} \frac{{f}_{i}^{liq}}{{f}_{i}^{vap}} = \frac{{ϕ}_{i}^{liq}}{{ϕ}_{i}^{vap}}$$
